(19) United States
(12) Patent Application Publication
(10) Pub. No.: US 2010/0139798 A1
(43) Pub. Date: Jun. 10, 2010

(54) In-flow liquid dispensing system

(76) Inventor: Arthur Raymond Schooley, JR., Lebanon, OR (US)

Correspondence Address: Francis I. Gray, P.O. Box 1931, Lake Oswego, OR, 97035, US

(21) Appl. No.: 12/592,931

(22) Filed: Dec. 4, 2009

Related U.S. Application Data
(60) Provisional application No. 61/201,076, filed on Dec. 5, 2008.

(51) Int. Cl. E03C 1/046; B05B 7/30; B05B 7/12

(52) U.S. Cl. 137/893; 137/888; 137/605; 137/861; 239/318; 239/407

(57) ABSTRACT

An in-flow liquid dispensing system has a connection point in a pipe between a water source and an outlet to which a liquid canister may be attached. At the connection point the pipe has parallel water paths, one path bypassing the liquid canister and the other including the liquid canister to inject the liquid from the canister into the water flow. One or more valves control the water flow through the respective paths to adjust the ratio of water to liquid from the canister, which may be either one path or the other or a combination of water flow through both paths.

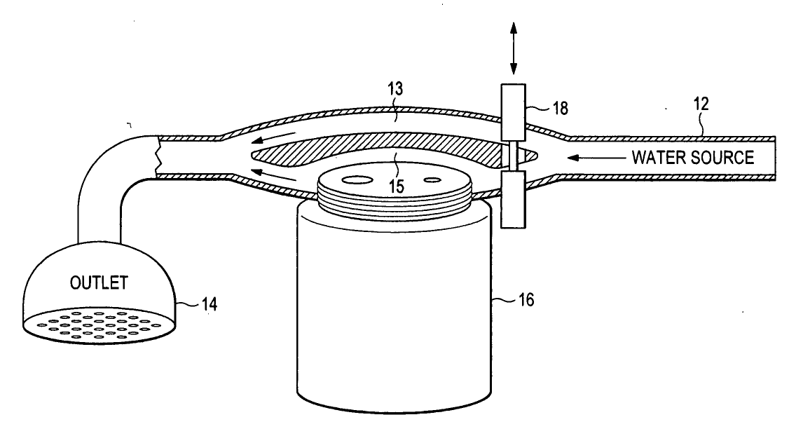

### CROSS-REFERENCE TO RELATED APPLICATIONS

The present application claims the filing date of Provisional U.S. Patent Application Ser. No. 61/201,076 filed Dec. 5, 2008 entitled “In-Flow Liquid Dispensing System”, which Provisional Application is hereby expressly abandoned upon the filing of the present application.

### BACKGROUND OF THE INVENTION

The present invention relates to plumbing accessories, and more particularly to an in-flow liquid dispensing system for showers, sinks or water basins and related conveniences.

Presently people using a shower, bath or sink for personal needs have separate containers for shampoo, conditioner, soap, etc., the contents of which are applied manually. This requires a shelf or niche to contain the containers, as well as requiring the use of hands in the application of the contents from the containers.

For the application of chemicals in the yard there exist hose attachment sprayers that contain the chemicals dissolved in water and include a nozzle for dissemination of the dilute chemicals when the sprayer is attached to a hose. These devices operate on the principal that the flow of water from the hose, through the sprayer to the nozzle, creates a sufficient vacuum to draw the dilute chemicals from the sprayer into the water flow. However nothing similar exists for showers, sinks or wash basins.

More recently a pet bathing system has been marketed that provides a product that may be attached to the end of a hose or may replace a shower head. The product contains a section to contain shampoo, which shampoo together with oxygen are injected into the water stream as the water stream passes from the connection end to a nozzle end. The product may be viewed at www.rapidbath.com.

What is desired is a simpler apparatus and method for dispensing liquids into a water stream, etc. via an existing shower head, for example, that leaves a person's hands free.

### BRIEF SUMMARY OF THE INVENTION

Accordingly the present invention provides an in-flow liquid dispensing system for distributing desired liquids into a water stream. A liquid canister is connected between a water source and a shower head or other water outlet via a suitable controllable valve. The canister may be filled with any appropriate liquid, such as soap, shampoo, conditioner, etc. In use a person turns on the valve to an appropriate setting to dispense a desired amount of the liquid into the water flow at the water outlet. The canister may be connected so that liquids may be gravity fed, vacuum fed or pump fed into the water flow, depending upon the viscosity of the liquid. For using water only, a valve may inhibit the dispensing of the liquid into the water flow.

The objects, advantages and other novel features of the present invention are apparent from the following detailed description when read in conjunction with the appended claims.

### BRIEF DESCRIPTION OF THE DRAWING

The Figure is a conceptual view of the in-flow liquid dispensing system according to the present invention.

### DETAILED DESCRIPTION OF THE INVENTION

Referring now to the Figure, a source of water travels along a pipe 12 to a water outlet 14, such as a shower head for example, from which a person uses the water for intended purposes, such as bathing, washing hair, etc. A liquid canister 16 is coupled in the pipe 12 at a convenient connection point prior to the water outlet 14. The pipe 12 at the connection point provides a parallel path for water flow between the source and the outlet 14. A bypass path 13 shunts the water flow past the liquid canister 16 to the outlet 14 and is controlled by a suitable valve 18, such as a push on/off valve. In the second position of the valve 18 the water flows in an injection path 15 across the top of the liquid canister 16 to disseminate the liquid into the water flow at the outlet 14. The valve 18 may be two separate valves, one to control the bypass path 13 and the other to control the injection path 15, and may be adjustable to control the mixture of water and liquid at the outlet 14. The liquid canister 16 may be detachably coupled to hang down from the pipe, or may be detachably coupled to be above the pipe. Depending upon the viscosity of the liquid being used, the type of delivery mechanism used to distribute the liquid may vary. For low viscosity liquids a vacuum delivery mechanism may be used with the liquid canister 16 hanging down from the pipe 12, such as that discussed above with reference to hose attachment sprayers. For higher viscosity liquids a gravity delivery mechanism may be used with the liquid canister 16 being above the pipe 12, i.e., the bypass and injection paths 13, 15 are inverted. Alternatively for higher viscosity liquids a pump (not shown) may be incorporated into the valve 18. The pump may be electric, or preferably an impeller type where the water flow through the pipe 12 causes the pump to operate.

In use a person starts the water flow through the pipe 12 in a conventional manner, typically through the use of faucets, after attaching the liquid canister 16 at the connection point that is incorporated as part of the pipe. The person then activates the valve 18 to produce a desired flow of the liquid into the water stream. The person uses the liquid, such as soap, shampoo, conditioner, scented oils, etc., for its intended purpose before adjusting the valve 18 to close the injection path 15 in order to rinse the liquid residue off with only water. Conceivably the liquid canister 16 may contain multiple liquids that are separately accessible its own valve (not shown), i.e., one position of the valve is liquid “one” (such as soap) and another position of the valve is liquid “two” (such as shampoo), while yet another position of the valve is liquid “three” (such as conditioner), etc. In the multiple liquid canister 16 the distribution mechanism may automatically be a vacuum mechanism for certain valve positions, corresponding to low viscosity liquids, and may be a pump mechanism for other valve positions, corresponding to higher viscosity liquids. Alternatively the pipe 12 may be plumbed with multiple connection points with corresponding parallel water paths and valves 18 to which different liquid canisters 16 may be coupled.

Also the valve 18 may be remotely controllable via a foot pedal or the like, such as for sinks and wash basins, especially where disinfectant liquids are used for sanitary purposes. Using the foot pedal makes the liquid dispenser suitable for hospitals, veterinary clinics, fast food and service restaurants, animal stalls, etc. to decrease the spread of germs on a faucet outlet and from hand to valve 18. Also other means for controlling the valve 18 may be used, such as touch or motion detectors.

Thus the present invention provides an in-flow liquid dispensing system for distributing suitable liquids into a shower, sink or wash basin water outlet stream by coupling the in-flow liquid canister to a valve plumbed into a water pipe having parallel flow paths between a water source and a water outlet, the liquid canister being coupled to inject the liquid into one of the flow paths. basins.

More recently a pet bathing system has been marketed that provides a product that may be attached to the end of a hose or may replace a shower head. The product contains a section to contain shampoo, which shampoo together with oxygen are infected into the water stream as the water stream passes from the connection end to a nozzle end. The product may be viewed at www.rapidbath.com.

What is desired is a simpler apparatus and method for dispensing liquids into a water stream, etc. via an existing shower head, for example, that leaves a person's hands free.

### BRIEF SUMMARY OF THE INVENTION

Accordingly the present invention provides an in-flow liquid dispensing system for distributing desired liquids into a wat

what is claimed is:

1. An in-flow liquid dispensing system comprising:
means for conveying a water stream from a source to an outlet;
a liquid canister containing a desired liquid; and
means for controllably coupling the liquid canister to the conveying means so that the desired liquid is distributed into the water stream as needed.

2. The system as recited in claim 1 wherein the coupling means comprises:
a pair of parallel water paths in the conveying means; and
means for connecting the liquid canister to one of the parallel water paths.

3. The system as recited in claim 2 wherein the coupling means further comprises a valve coupled to control flow of the water stream through a selected one of the parallel water paths.

4. The system as recited in claim 2 wherein the coupling means further comprises a valve coupled to control flow of the water stream through the parallel water paths in order to adjust a ratio of the desired liquid from the liquid canister to the flow of the water stream.

5. The system as recited in claim 2 wherein the connecting means comprises a connector to one of the parallel paths for the liquid canister that allows vacuum distribution of the liquid from the liquid canister into the water stream.

6. The system as recited in claim 2 wherein the connecting means comprises a connector to one of the parallel paths for the liquid canister that allows a gravity distribution of the liquid from the liquid canister into the water stream.

7. The system as recited in claim 1 further comprising a pump coupled to the liquid canister to forcibly distribute the desired liquid from the liquid canister into the water stream.

8. The system as recited in claim 7 wherein the pump comprises an electric pump.

9. The system as recited in claim 7 wherein the pump comprises an impeller pump that operates in response to the water stream flowing through the conveying means.

10. The system as recited in claim 1 wherein the liquid canister comprises:
a canister containing a plurality of different desired liquids; and
means for selecting a desired one of the different desired liquids for distribution into the water stream.

11. The system as recited in claim 1 further comprising additional liquid canisters, each liquid canister containing a different desired liquid and having its own means for controllably coupling the liquid canister to the conveying means.

12. The system as recited in claim 1 wherein the controllably coupling means comprises a foot pedal for controlling the distribution of the desired liquid from the liquid canister into the water stream.

13. The system as recited in claim 1 wherein the controllably coupling means comprises a motion sensor for controlling the distribution of the desired liquid from the liquid canister into the water stream.
